(19) United States
(12) Patent Application Publication
(10) Pub. No.: US 2019/0016380 A1
(43) Pub. Date: Jan. 17, 2019

(54) Rear Wheel Steering System

(71) Applicant: Mario Gullo, Elk Grove, IL (US)

(72) Inventor: Mario Gullo, Elk Grove, IL (US)

(21) Appl. No.: 15/650,394

(22) Filed: Jul. 14, 2017

(51) Int. Cl. B62D 7/14; B60G 21/04; B62D 6/00

(52) U.S. Cl. CPC B62D 7/14; B62D 6/00; B62D 7/146; B60G 21/04

(57) ABSTRACT

A rear wheel steering system includes a vehicle that has a solid rear axle, a first drive shaft, a second drive shaft and a steering system. The solid rear axle includes a pair of rear wheels and the solid rear axle is pivotally coupled to the vehicle. A gear box is coupled to the vehicle and the gear box is operationally coupled to the steering system. The gear box is positioned at an intersection between the first drive shaft and the second drive shaft. Moreover, the gear box engages the second drive shaft such that the gear box urges the second drive shaft into the selected angle when the steering system is manipulated. In this way the solid rear axle facilitates the rear wheels to steer the vehicle in conjunction with front wheels of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to steering devices and more particularly pertains to a new steering device for facilitating rear wheels of a vehicle to assist in turning the vehicle.

### BRIEF SUMMARY OF THE INVENTION

An embodiment of the disclosure meets the needs presented above by generally comprising a vehicle that has a solid rear axle, a first drive shaft, a second drive shaft and a steering system. The solid rear axle includes a pair of rear wheels and the solid rear axle is pivotally coupled to the vehicle. A gear box is coupled to the vehicle and the gear box is operationally coupled to the steering system. The gear box is positioned at an intersection between the first drive shaft and the second drive shaft. Moreover, the gear box engages the second drive shaft such that the gear box urges the second drive shaft into the selected angle when the steering system is manipulated. In this way the solid rear axle facilitates the rear wheels to steer the vehicle in conjunction with front wheels of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a rear wheel steering system according to an embodiment of the disclosure.

FIG. 2 is a top phantom view of an embodiment of the disclosure in a straight position.

FIG. 3 is a top phantom view of an embodiment of the disclosure in a left turn position.

FIG. 4 is a top phantom view of an embodiment of the disclosure in a right turn position.

### DETAILED DESCRIPTION OF THE INVENTION

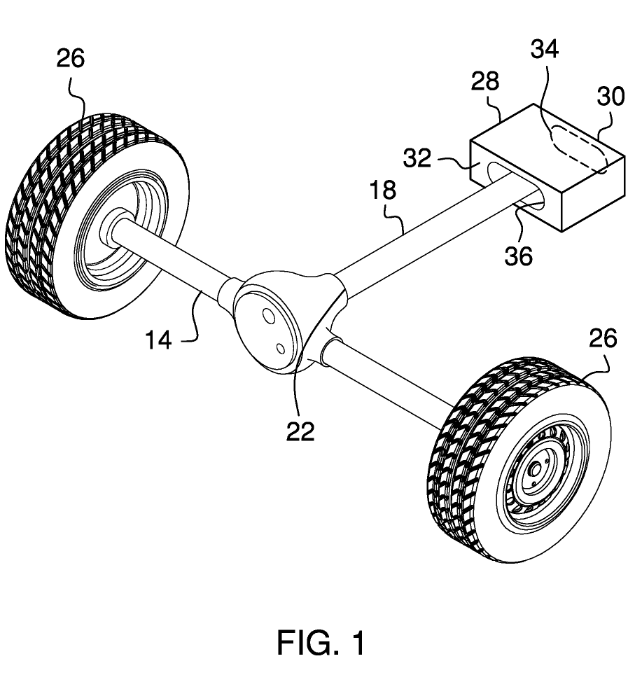

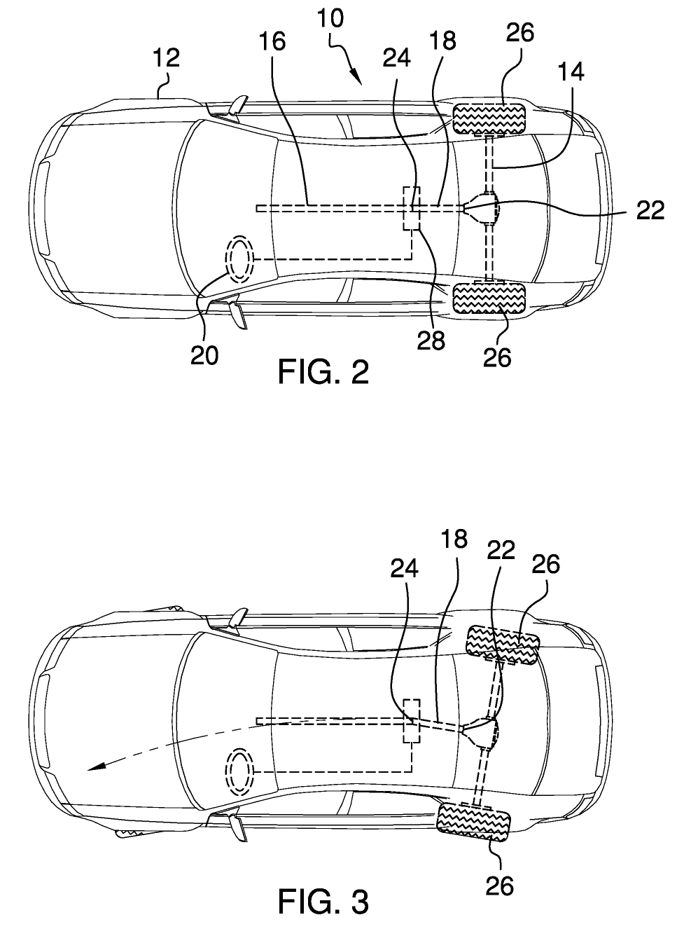

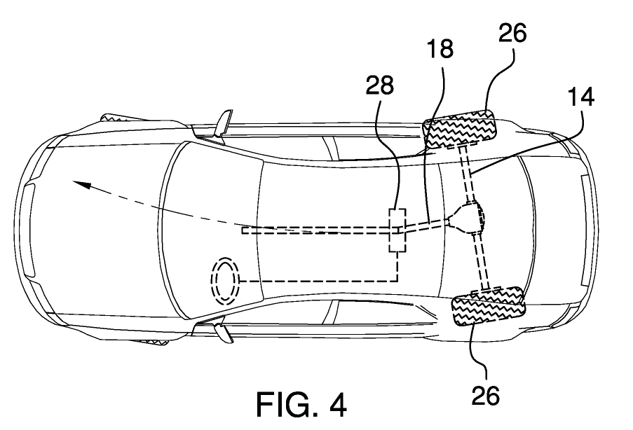

With reference now to the drawings, and in particular to FIGS. 1 through 4 thereof, a new steering device embodying the principles and concepts of an embodiment of the disclosure and generally designated by the reference numeral 10 will be described.

As best illustrated in FIGS. 1 through 4, the rear wheel steering system 10 generally comprises a vehicle 12 that has a solid rear axle 14, a first drive shaft 16, a second drive shaft 18 and a steering system 20. The first drive shaft 16 may be coupled to a transmission in the vehicle 12 to transfer rotational torque into the first drive shaft 16. The solid rear axle 14 may include a differential and other mechanical components common to solid rear axles in rear wheel drive vehicles. The vehicle 12 may be a passenger vehicle, a cargo vehicle and any other rear wheel drive vehicle and the steering system 20 may include a steering wheel.

The second drive shaft 18 has a first end 22 and a second end 24. The first end 22 is rotatably coupled to the solid rear axle 14 and the second end 24 is pivotally coupled to the first drive shaft 16. In this way the second drive shaft 18 is positionable at a selected angle with respect to the first drive shaft 16. Each of the first 16 and second 18 drive shafts may include universal joints and yokes common to vehicle drive shafts. The connection between the first end 22 and the solid rear axle 14 is accomplished, through a bearing or the like, such that the second drive shaft 18 is retained at a perpendicular orientation with the solid rear axle 14.

The solid rear axle 14 includes a pair of rear wheels 26 and the solid rear axle 14 is pivotally coupled to the vehicle 12. The solid rear axle 14 is selectively positioned in a straight position having the second drive shaft 18 being orientated collinear with the first drive shaft 16. In this way the rear wheels 26 are positioned to urge the vehicle 12 forwardly in a straight line. The solid rear axle 14 is selectively positioned in a left turn position having the second drive shaft 18 being oriented at a selected angle with respect to the first drive shaft 16. In this way the rear wheels 26 are positioned to urge the vehicle 12 into a left turn. The solid rear axle 14 is selectively positioned in a right turn position having the second drive shaft 18 being oriented at a selected angle with respect to the first drive shaft 16. In this way the rear wheels 26 are positioned to urge the vehicle 12 into a right turn.

A gear box 28 is provided and the gear box 28 is coupled to the vehicle 12. The gear box 28 is operationally coupled to the steering system 20 and the gear box 28 is positioned at an intersection between the first drive shaft 16 and the second drive shaft 18. The gear box 28 engages the second drive shaft 18 such that the gear box 28 urges the second drive shaft 18 into the selected angle when the steering system 20 is manipulated. In this way the rear wheels 26 are selectively positioned to steer the vehicle 12. The gear box 28 has a front side 30 and a back side 32. The front side 30 has a first aperture 34 extending into the gear box 28 and the back side 32 has a second aperture 36 extending into the gear box 28. The first drive shaft 16 extends through the first aperture 34 and the second drive shaft 18 extends through the second aperture 36.

The gear box 28 may include a motor that is in mechanical communication with the second drive shaft 18. The motor may be an electric motor, a hydraulic motor and any other type of motor that is capable of generating rotational torque. The gear box 28 may additionally include a processor that is electrically coupled to the motor and the steering system 20. Moreover, the processor may turn the motor on to rotate in a direction corresponding to manipulation of the steering system 20. The motor may engage the second drive shaft 18 through any applicable mechanical means, to include but not be limited to, a complementary set of gears, rollers, a rack and pinion and any other mechanism that is capable of urging the second drive shaft 18 into the selected angle without inhibiting rotation of the second drive shaft 18.

In use, the vehicle 12 is selectively driven and the steering system 20 is manipulated when the vehicle 12 is driven. The gear box 28 urges the second drive shaft 18 into the selected angle when the steering system 20 is manipulated to perform a left turn. In this way the rear wheels 26 act in tandem with front wheels of the vehicle 12 to accomplish the left turn. The gear box 28 urges the second drive shaft 18 into the selected angle when the steering system 20 is manipulated to perform a right turn. Thus, the rear wheels 26 act in tandem with the front wheels to accomplish the right turn. The gear box 28 urges the second drive shaft 18 into being oriented collinear with the first drive shaft 16 when the steering system 20 is manipulated to drive the vehicle 12 in a straight line.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rear wheel steering system comprising:
a vehicle having a solid rear axle, a first drive shaft, a second drive shaft and a steering system, said solid rear axle including a pair of rear wheels, said solid rear axle being pivotally coupled to said vehicle; and
a gear box being coupled to said vehicle, said gear box being operationally coupled to said steering system, said gear box being positioned at an intersection between said first drive shaft and said second drive shaft, said gear box engaging said second drive shaft such that said gear box urges said second drive shaft into said selected angle when said steering system is manipulated thereby facilitating said rear wheels to steer said vehicle.

2. The system according to claim 1, wherein said second drive shaft has a first end and a second end, said first end being pivotally coupled to said solid rear axle, said second end being pivotally coupled to said first drive shaft such that said second drive shaft is positionable at a selected angle with respect to said first drive shaft.

3. The system according to claim 2, wherein said solid rear axle is selectively positioned in a straight position having said second drive shaft being orientated collinear with said first drive shaft such that said rear wheels are positioned to urge said vehicle forwardly.

4. The system according to claim 2, wherein said solid rear axle is selectively positioned in a left turn position having said second drive shaft being oriented at a selected angle with respect to said first drive shaft such that said rear wheels are positioned to urge said vehicle into a left turn.

5. The system according to claim 2, wherein said solid rear axle is selectively positioned in a right turn position having said second drive shaft being oriented at a selected angle with respect to said first drive shaft such that said rear wheels are positioned to urge said vehicle into a right turn.

6. The system according to claim 2, wherein said gear box urges said second drive shaft into said selected angle when said steering system is manipulated to perform a left turn.

7. The system according to claim 2, wherein said gear box urges said second drive shaft into said selected angle with said steering system is manipulated to perform a right turn.

8. The system according to claim 2, wherein said gear box urges said second drive shaft into being oriented collinear with said first drive shaft when said steering system is manipulated to drive said vehicle in a straight line.

9. A rear wheel steering system comprising:
a vehicle having a solid rear axle, a first drive shaft, a second drive shaft and a steering system, said second drive shaft having a first end and a second end, said first end being pivotally coupled to said solid rear axle, said second end being pivotally coupled to said first drive shaft such that said second drive shaft is positionable at a selected angle with respect to said first drive shaft, said solid rear axle including a pair of rear wheels, said solid rear axle being pivotally coupled to said vehicle, said solid rear axle being selectively positioned in a straight position having said second drive shaft being orientated collinear with said first drive shaft such that said rear wheels are positioned to urge said vehicle forwardly, said solid rear axle being selectively positioned in a left turn position having said second drive shaft being oriented at a selected angle with respect to said first drive shaft such that said rear wheels are positioned to urge said vehicle into a left turn, said solid rear axle being selectively positioned in a right turn position having said second drive shaft being oriented at a selected angle with respect to said first drive shaft such that said rear wheels are positioned to urge said vehicle into a right turn; and
a gear box being coupled to said vehicle, said gear box being operationally coupled to said steering system, said gear box being positioned at an intersection between said first drive shaft and said second drive shaft, said gear box engaging said second drive shaft such that said gear box urges said second drive shaft into said selected angle when said steering system is manipulated thereby facilitating said rear wheels to steer said vehicle, said gear box urging said second drive shaft into said selected angle when said steering system is manipulated to perform a left turn, said gear box urging said second drive shaft into said selected angle with said steering system is manipulated to perform a right turn, said gear box urging said second drive shaft into being oriented collinear with said first drive shaft when said steering system is manipulated to drive said vehicle in a straight line.
